(19) United States
(12) Patent Application Publication
(10) Pub. No.: US 2018/0093368 A1
(43) Pub. Date: Apr. 5, 2018

(54) Hose Removal System and Method

(71) Applicant: Kwalija Harroff, Chetwynd (CA)

(72) Inventor: Kwalija Harroff, Chetwynd (CA)

(21) Appl. No.: 15/284,467

(22) Filed: Oct. 3, 2016

(51) Int. Cl. B25B 27/10; B25B 7/22; B25B 7/14

(52) U.S. Cl. CPC B25B 27/10; B25B 7/14; B25B 7/22

(57) ABSTRACT

A long handled, locking jaw plier tool for the effective removal of hoses includes an elongated handle for reaching difficult-to-reach areas, jaws with a plurality of sharp teeth for gripping hoses, a locking mechanism for locking the jaws in the closed position, actuating pins for removing a hose from its fixture and a heating element for warming and expanding a hose to aid in its removal.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of tools and more specifically relates to a long handled locking jaw plier tool.

### 2. DESCRIPTION OF RELATED ART

When working in a mechanical field, a person is often confronted with the task of removing hoses from various fittings and fixtures. Many hoses carry critical cooling fluids or pressurized liquids to various components of machinery. The stresses endured by these hoses can often lead to the hoses becoming deteriorated or bonded to the machine's fixtures. Hoses that are exposed to hot liquids can also expand and retract making their removal from their fixtures a difficult and often frustrating task. Some hoses are in cramped locations that would be difficult to reach by hand. Other hoses are sometimes too large or too small to enable removal by hand. Some tools created for the removal of hoses are too short to reach these difficult-to-reach areas. Many tools are sized specifically for hoses and cannot be used on a multitude of hoses which can necessitate the purchase of several of these tools which can be costly and bulky for a mechanic to carry around. Other means of removing hoses can require a user to use their hands gripping power to clamp onto the hose for removal. This can prove difficult in small spaces or at awkward angles. Still even more tools are designed for the removal of hose clamps and do not facilitate removal of the hose itself. A suitable solution is desired.

Several attempts have been made to solve the above-mentioned problems such as those found in U.S. Pat. No. 4,571,808 to King, U.S. Pat. No. 9,216,494 to Lai and U.S. Pat. No. 3,715,794 to Holcombe & McCollum. This art is representative of tools. However, none of the above inventions and patents, taken either singly or in combination, is seen to describe the invention as claimed.

### BRIEF SUMMARY OF THE INVENTION

In view of the foregoing disadvantages inherent in the known tools art, the present invention provides a novel long handled locking jaw plier tool. The general purpose of the present invention, which will be described subsequently in greater detail is to provide an effective means for hose removal.

A long handled locking jaw plier tool is disclosed herein, in a preferred embodiment, comprising: a first jaw statically mounted to a first handle, wherein the first jaw comprises a plurality of sharp, gripping teeth. The first handle further comprises an elongated handle; wherein the elongated handle contains a shaft connected to two straight-toothed gears. The elongated handle further comprises a protruding Allen head screw for rotation of the geared shaft contained within the elongated handle. A second jaw is mounted pivotal to a second handle; wherein the second jaw also comprises a plurality of sharp, gripping teeth. The second jaw is pivotable in relation to the first jaw by actuation of the second handle. The second handle contains a locking mechanism for locking said second jaw in a closed, locked position and supports a lever for releasing the locking mechanism. The jaws further comprise actuating pins for disengaging the hose with a fixture, wherein the pins are preferably actuated by the geared shaft contained within the handle.

A heating element to expand a hose to facilitate swift removal is provided wherein the heating element is powered by a power source. The power source may comprise a battery compartment or a terminal for connection to an external power source. The jaws further comprise an attachable cone-shaped element to allow for gripping of hoses of various sizes.

A long handled locking jaw plier tool is further disclosed herein, in a preferred embodiment comprising a kit including the aforementioned long handled locking jaw plier tool, a heating element, a power source for the heating element, the aforementioned cone-shaped jaw attachment and a set of user instructions or any combination thereof.

According to another embodiment, a method for using long handled locking jaw plier tool is also disclosed herein. The method for providing effective means for hose removal includes the steps of: providing a long handled plier tool, attaching the long handled plier tool to a hose, allowing the heating element to warm and expand the hose and removing the hose, then actuating the locking mechanism release lever to release the gripping end of the long handled plier tool from the hose.

The present invention holds significant improvements and serves as a long handled locking jaw plier tool. Preferably, tools should provide effective means for hose removal and, yet would operate reliably and be manufactured at a modest expense. Thus, a need exists for a reliable long handled locking jaw plier tool to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, long handled locking jaw plier tool, constructed and operative according to the teachings of the present disclosure.

FIG. 1 shows a perspective view illustrating a long handled locking jaw plier tool during an ‘in-use’ condition according to an embodiment of the disclosure.

FIG. 2 is a perspective view illustrating the long handled locking jaw plier tool comprising a first and second handle supporting a first and second jaw assembly according to an embodiment of the present invention of the disclosure.

FIG. 3 is a perspective view illustrating the locking mechanism assembly according to an embodiment of the present disclosure.

FIG. 4 is a perspective view illustrating the actuating hose disengagement pin assembly according to an embodiment of the present disclosure.

FIG. 5 is a flow diagram illustrating a method of use for the long handled locking jaw plier tool according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to tools and more particularly to a long handled locking jaw plier tool 110 as used to improve the effective means for hose removal.

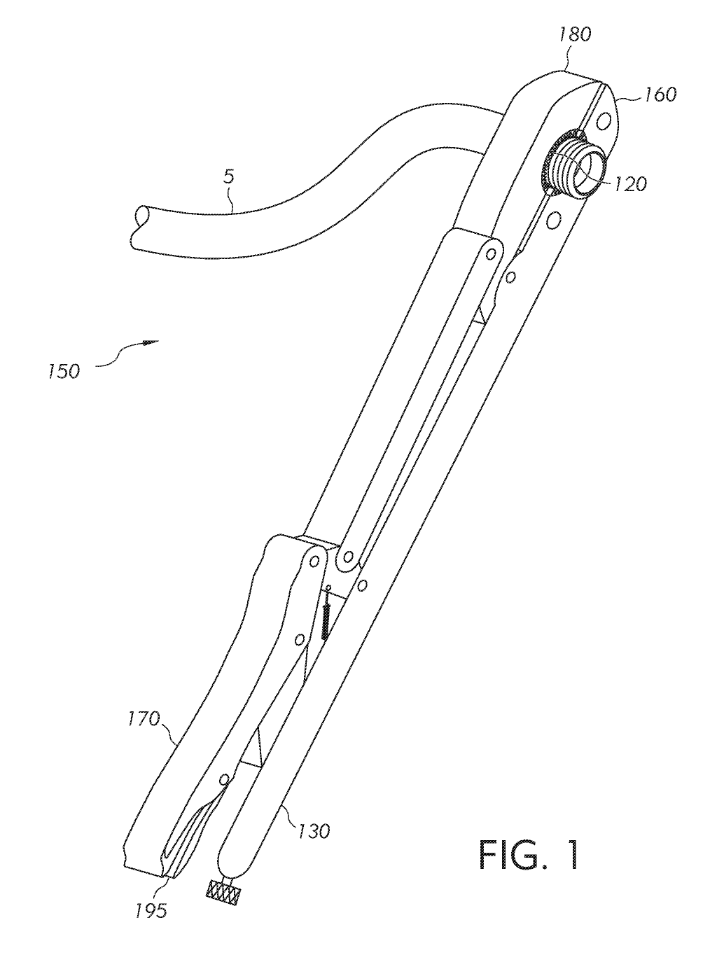

Referring more now more specifically to the drawings by numerals of reference there is shown in FIGS. 1-4, various views of long handled locking jaw plier tool 110. Hose removal system 100 comprised of a long handled locking jaw plier tool 110 wherein the tool is provided with a first stationary elongated handle 130 which supports a first stationary jaw 160 having numerous short sharpened teeth 120 for gripping a hose. The first stationary, elongated handle 130 further serves as a housing for a geared shaft 420 having two straight toothed gears 430 mounted thereto which actuates the pins 410 for disengaging the hose 5 from its fixture. Also included within the first stationary, elongated handle 130 is an Allen head screw 320 or bolt which upon its rotation will extrude or retract the pins 410 to push against a solid surface, thereby removing the hose 5 from its fixture.

The aforementioned pins 410 are mounted on opposing sides of the first stationary jaw 160 to allow them to push against a solid surface and pull a hose 5 away from its fixture. These pins are tracked or geared and propelled by the geared shaft 420 contained within the first stationary, elongated handle 130. The geared shaft 420 is actuated by the rotation of the allen head screw 320, when rotated to retract the pins 410 the tool is clamped onto a hose 5 for removal. When the allen head screw 320 is rotated to extrude the pins 410, the pins 410 are used as a leverage point against a solid surface to remove the hose 5 from its fixture.

Furthermore, the long handled locking jaw plier tool 110 disclosed herein is preferably comprised of a second pivotal elongated handle 170 which pivotally supports a second pivotal jaw 260 having numerous short sharpened teeth 120 for gripping a hose 5. The second movable elongated handle 250 also serves as a housing for a locking mechanism 300 which will lock the jaws 210 of the tool in the closed position. The second movable elongated handle 250 also supports a locking mechanism release lever 195 for releasing the locking mechanism 300. The locking mechanism 300 provided is one that operates on the basic principle of an over-center linkage locking system which prevents the jaws 210 from being opened by a force applied to the jaws 210 themselves. Instead the jaws 210 must be unlocked by actuation of the locking mechanism release lever 195 provided.

The long handled locking jaw plier tool 110 may have a heating element 295 which serves to warm and expand a hose 5 which is being removed by the long handled locking jaw plier tool 110. This heating element 295 is relative directly to the jaws 210 of the long handled locking jaw plier tool 110 in that the heat is applied to the hose 5 directly through the jaws 210 to the area that is being gripped by the long handled locking jaw plier tool 110. The heating element 295 is provided in the preferred embodiment as integral to the tool but may also be provided as an additional component provided separately. This heating element 295 is further provided as having a power source 290 which is integrated into the heating element 295 either by battery operation or by terminal 280 allowing connection to an external power source 290.

Another essential component of the long handled locking jaw plier tool 110 is a cone-shaped attachment 330 for attachment to the jaws 210 to allow the jaws 210 to grip hoses of varying sizes. This component is attached to the jaws 210 by an appropriate, non-permanent method such as removable screws, bolts or clamps to allow for use when necessary without permanently altering the arrangement of the long handled locking jaw plier tool 110 itself.

Referring now to FIG. 1 showing the long handled locking jaw plier tool 110 in use according to the preferred embodiment. The jaws 210 of the long handled locking jaw plier tool 110 are represented with a plurality of teeth 120 to facilitate a strong gripping relationship with a hose 5. The elongated handles 200 of the tool are visible showing their aptitude for reaching hard-to-reach areas. The relationship of the elongated handles 200 with the jaws 210 of the long handled locking jaw plier tool 110 is readily visible, the first handle 130 mounted to the first jaw 160, a second handle 170 and second jaw 180 connected pivotably to the first handle 130 and first jaw 160 such that movement of the second handle 170 in relation to the stationary handle 230 causes the jaws 210 to open and close. Also visible is the position of the locking mechanism release lever 195 in cooperative relationship with the second handle 170 of the tool. The long handled locking jaw plier tool 110 is shown to use a push type locking mechanism release lever 195 where one end of the lever is pushed toward the handle to force the opposite end of the lever into engagement with the linkage of the locking mechanism 300.

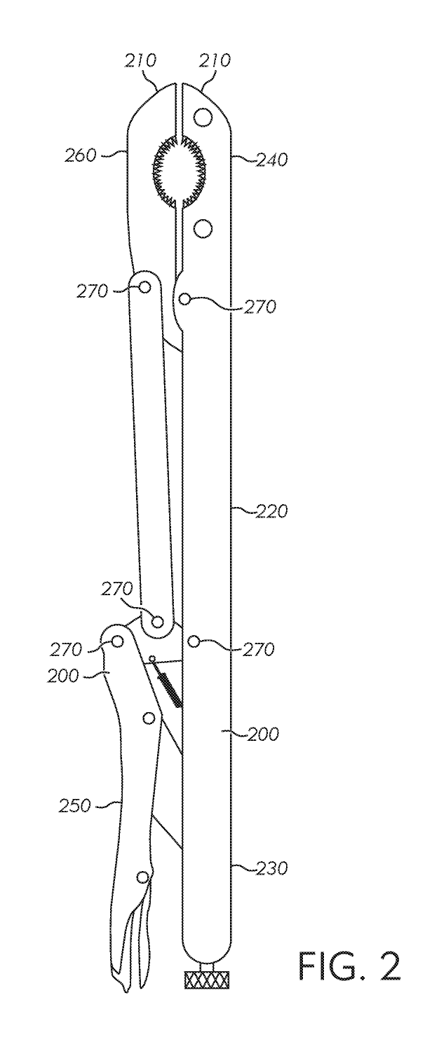

FIG. 2 details the overall layout of the basic components of the handles 200 and jaws 210 and their relationship to each other. Shown is a stationary arm 220 having at one end a stationary handle 230 and at the other end a stationary jaw 240. Also shown is a movable handle 250 having at one end a stationary handle 230 and at the opposite end a pivotable jaw 260 connected to the movable handle 250 by a pivot point 270. Similarly, the pivotable jaw 260 is connected to the stationary arm 220 by another pivot point 270. At the distal end of the stationary handle 230 there is provided a terminal 280 for connection of an external power source 290. This power source 290 may be provided as an integral power source 290 such as one powered by a battery. The power source 290 provides power to the gripping surface of the jaws 210 which is heatable by an electronic heating element 295 to heat and expand a hose 5.

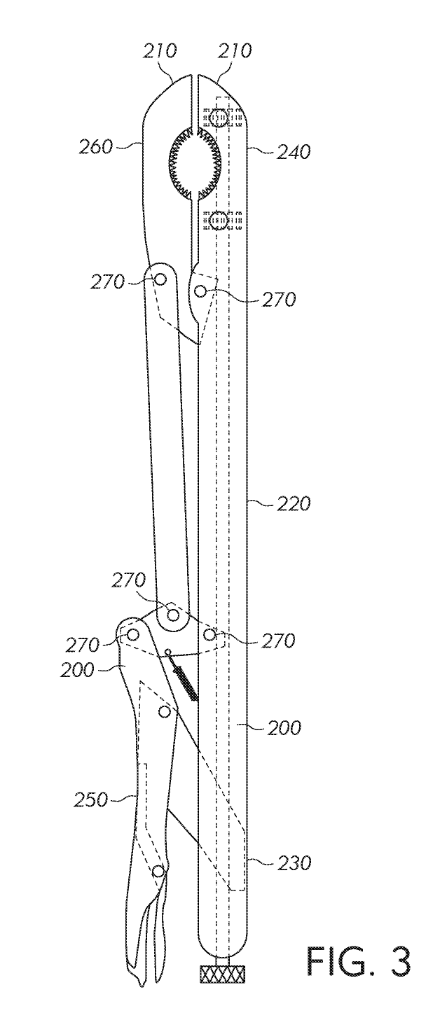

FIG. 3 best represents a preferred embodiment of the positioning of the internal components of the long handled locking jaw plier tool 110. As detailed in the drawing, a link 310 is pivotably connected to the movable handle 250 by pivot point 270 and is further supported by its termination in abutment with the stationary handle 230. The adjustment of the allen head screw 320 adjusts the positioning of the pins 410 and through the geared shaft 420 extrudes and retracts the pins 410 upon its rotation. A simple single link locking mechanism is shown and may further include a complex compound linkage.

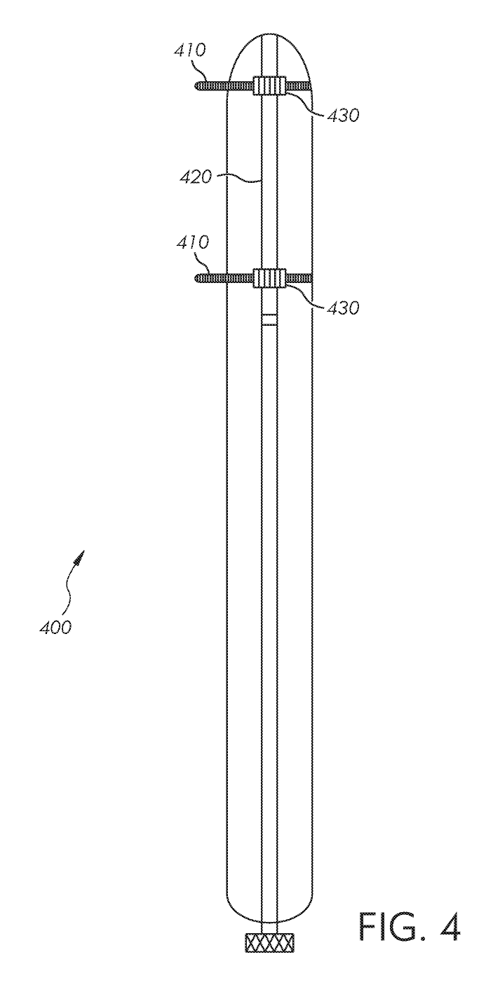

FIG. 4 depicts the actuating hose disengagement pin assembly 400. The pins 410, actuated by a geared shaft 420 housed within the stationary jaw 240 of the long handled locking jaw plier tool 110. The geared shaft is further connected to and actuated by the allen head screw 320 located at the distal end of the stationary handle 230. The rotation of the allen head screw 320 retracts the pins 410 into the first jaw 160 to allow the long handled locking jaw plier tool 110 to be locked in place onto a hose 5. Upon opposite rotation of the allen head screw 320 the pins 410 are extruded from the first jaw 160 to impact a solid surface and facilitate the removal of the hose 5 from its fixture. The gears 430 of the geared shaft 420 are cooperatively engaged with the pins 410 in that upon their rotation, the gears 430 will extend and retract the pins 410 upon rotation of the allen head screw 320.

Hose removal system 100 may be sold as a kit comprising the following parts: at least one long handled locking jaw plier tool 110; at least one power source 290; at least one cone-shaped attachment 330; and at least one set of user instructions. The kit has instructions such that functional relationships are detailed in relation to the structure of the invention (such that the invention can be used, maintained, or the like in a preferred manner).

Hose removal system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different jaw and heating means and combinations, parts may be sold separately, etc., may be sufficient.

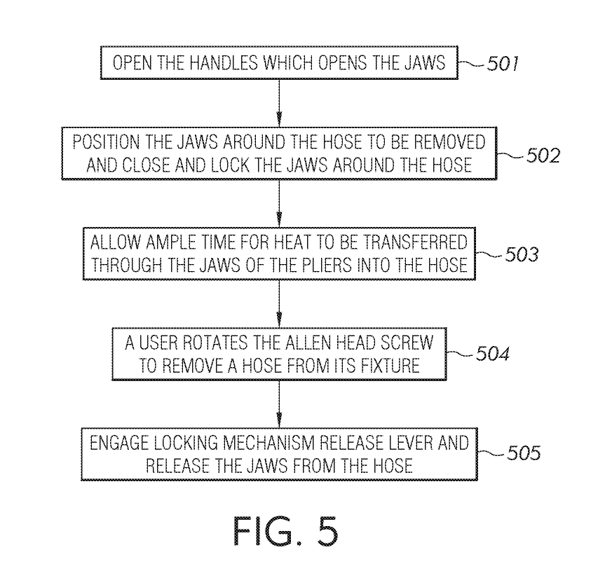

Referring now to FIG. 5 showing a flow diagram 550 illustrating method of use 500 for hose removal system 100 according to an embodiment of the present invention of FIGS. 1-4. As shown, method of use 500 may comprise the steps of: step one 501, a user opens the handles of the tool which in turn open the jaws of the tool; step two 502, a user positions the jaws of the tool around a desired hose and closes the handles forming a locking relationship with the jaws of the tool and a hose; step three 503, a user allows ample time for the heating element to heat and expand a hose; step four 504, a user rotates the allen head screw to remove a hose from its fixture; step five 505, a user engages the locking mechanism release lever which unlocks the jaws and allows the handles to be manipulated into an open position, releasing the jaws from their grip on a hose.

It should be noted that step 503 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A hose removal tool system comprising:
a. a locking jawed plier tool assembly comprising;
i. a long handled plier tool having jaws lined with a plurality of teeth for gripping a hose;
ii. wherein a handle is elongated for reaching difficult-to-reach-areas;
iii. wherein said handle includes a locking mechanism for locking said jaws in a closed position;
iv. wherein said jaws have pins attached thereto which protrude to disengage said hose with a fixture;
v. wherein said plier tool includes a heating element for heating and expanding said hose; and
vi. wherein said locking jawed plier tool assembly is structured and arranged to facilitate heating and expanding said hose and positive grip on and removal of said hose in said difficult-to-reach areas.

2. The hose removal tool system of claim 1 wherein said jaws comprise a first jaw mounted stationary to said handle and a second, pivotal jaw mounted to said handle.

3. The hose removal tool system of claim 1 wherein said jaws further comprise a plurality of sharp teeth to facilitate a sustainable gripping relationship with a hose.

4. The hose removal tool system of claim 1 wherein said elongated handle comprises a first handle supporting said first jaw.

5. The hose removal tool system of claim 1 wherein said elongated handle comprises a second handle movable in relation to said first handle to actuate said second jaw between an open and a closed, locked position.

6. The hose removal tool system of claim 4 wherein said first handle comprises a protruding Allen head screw for adjustment of pins.

7. The hose removal tool system of claim 6 wherein said first handle contains a shaft connected to two straight-tooth gears.

8. The hose removal tool system of claim 5 wherein said second handle contains a locking mechanism for locking the pivotal second jaw in a closed position.

9. The hose removal tool system of claim 1 wherein said second handle supports a lever for disengaging said locking mechanism.

10. The hose removal tool system of claim 1 wherein said jaws further comprise actuating pins for disengaging said hose with said fixture.

11. The hose removal tool system of claim 10 wherein said pins are actuated by a geared shaft.

12. The hose removal tool system of claim 1 wherein said plier tool comprises a heating element to heat said hose to expand and facilitate efficient and effective removal.

13. The hose removal tool system of claim 12 wherein said plier tool further comprises a power source for powering said heating element.

14. The hose removal tool system of claim 13 wherein said power source comprises a battery compartment.

15. The hose removal tool system of claim 14 wherein said power source comprises a terminal for connection to an external power source.

16. The hose removal tool system of claim 1 wherein said jaws further comprise an attachable cone-shaped element to allow for gripping of said hoses of various sizes.

17. A hose removal tool system comprising:
a. a locking jawed plier tool assembly comprising;
i. a long handled plier tool having jaws lined with a plurality of teeth for gripping a hose;
ii. wherein a handle is elongated for reaching difficult-to-reach-areas;
iii. wherein said handle includes a locking mechanism for locking said jaws in a closed position;
iv. wherein said jaws have pins attached thereto which protrude to disengage said hose with a fixture;
v. wherein said jaws comprise a first jaw mounted stationary to said handle and a second, pivotal jaw mounted to said handle;
vi. wherein said jaws further comprise a plurality of sharp teeth to facilitate a sustainable gripping relationship with a hose;
vii. wherein said elongated handle comprises a first handle supporting said first jaw;
viii. wherein said plier tool includes a heating element for heating and expanding said hose; and
ix. wherein said locking jawed plier tool assembly is structured and arranged to facilitate heating and expanding said hose and positive grip on and removal of said hose in said difficult-to-reach areas.

18. The hose removal tool system of claim 17 further comprising a kit including:
said long handled plier tool;
said heating element;
said power source;
said cone attachment; and
a set of user instructions

19. A method of using a hose removal tool system comprising the steps of:
providing a long handled plier tool;
attaching said long handled plier tool to a hose;
allowing a heating element to warm and expand said hose; and
removing said hose.

20. The method of claim 19 further comprising the steps of
actuating a locking mechanism release lever to release a gripping end of said long handled plier tool from said hose.
